(19) United States
(12) Patent Application Publication
(10) Pub. No.: US 2024/0302721 A1
(43) Pub. Date: Sep. 12, 2024

(54) POSTURE ADJUSTMENT DEVICE

(71) Applicant: Hanwha Vision Co., Ltd., Seongnam-si (KR)

(72) Inventor: Dae Kyung KIM, Seongnam-si (KR)

(73) Assignee: Hanwha Vision Co., Ltd., Seongnam-si (KR)

(21) Appl. No.: 18/392,712

(22) Filed: Dec. 21, 2023

(30) Foreign Application Priority Data
Mar. 7, 2023 (KR) 10-2023-0030056
Sep. 26, 2023 (KR) 10-2023-0129114

(51) Int. Cl. G03B 17/56; H04N 23/51

(52) U.S. Cl. CPC G03B 17/561; H04N 23/51

(57) ABSTRACT

A posture adjustment device includes a base having a rotation axis that extends through a center of the base, a central camera assembly coupled to the base and configured to rotate about the rotation axis, and at least one peripheral camera assembly coupled to the base and configured to revolve around the rotation axis.

### CROSS-REFERENCE TO RELATED APPLICATION(S)

This application is based on and claims priority to Korean Patent Application No. 10-2023-0129114, filed on Sep. 26, 2023, in the Korean Intellectual Property Office, and Korean Patent Application No. 10-2023-0030056, filed on Mar. 7, 2023, the disclosures of which are incorporated herein by reference in their entireties.

### BACKGROUND

### 1. Field

The disclosure relates to a posture adjustment device, and more particularly, to a posture adjustment device which may adjust the positions of peripheral cameras around a central camera.

### 2. Description of Related Art

A camera may be used to monitor a target place. A user may monitor the target place by referring to images captured by the camera.

If the camera is pointed at only one point, a surveillance area may be limited. Therefore, pan-tilt equipment may be mounted on the camera to change the photographing direction of the camera. The pan-tilt equipment may change the photographing direction at the user's request or automatically, and the camera may perform photographing in the changed photographing direction.

However, even if the pan-tilt equipment is mounted on the camera, it may not be easy to monitor a plurality of different points. In addition, if a plurality of cameras are used to monitor a plurality of points, excessive installation costs and management costs may be incurred.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

Provided is a posture adjustment device which may adjust the positions of peripheral cameras around a central camera, thereby allowing a plurality of different points to be monitored with lower installation and management costs.

Additional aspects will be set forth in part in the description which follows and, in part, will be apparent from the description, or may be learned by practice of the presented embodiments.

According to an aspect of the disclosure, a posture adjustment device may include a base having a rotation axis that extends through a center of the base, a central camera assembly coupled to the base and configured to rotate about the rotation axis, and at least one peripheral camera assembly coupled to the base and configured to revolve around the rotation axis.

The base may include a base ring providing a movement path for the at least one peripheral camera assembly.

The at least one peripheral camera assembly may include a plurality of peripheral camera assemblies, and each of the plurality of peripheral camera assemblies may be configured individually move along the base ring.

The at least one peripheral camera assembly may include a moving body configured to move along the base ring and a peripheral camera coupled to the moving body.

The base ring may include a ring gear, and the at least one peripheral camera assembly may include a first power gear coupled to the ring gear and a first power motor configured to generate a rotational force to rotate the first power gear.

The at least one peripheral camera assembly may include a force providing assembly configured to generate a force to bring the first power gear into contact with the ring gear.

The base ring may include a support ring around the ring gear, and the force providing assembly may include a bullet movably coupled to the moving body and contacting the support ring and an elastic portion providing the bullet with an elastic force directed toward the support ring.

The force providing assembly may be provided on both sides of the first power gear.

The base ring may include a ring body having a central axis that corresponds to the rotation axis of the base, and a guide ring protruding from an outer surface of the ring body, and the moving body may include an engaging portion configured to engage with the guide ring.

The engaging portion may include an engaging protrusion protruding toward a first surface of the guide ring.

The moving body may include a body protrusion protruding toward a second surface of the guide ring that is opposite the first surface of the guide ring that the engaging protrusion protrudes toward.

The engaging portion may be detachable from the moving body.

The peripheral camera may be rotatably coupled to the moving body.

The base may include a base cylinder provided at a center of the base ring.

The central camera assembly may be rotatably coupled to the base cylinder.

The base cylinder may include a cylinder body and a cylinder ring protruding from an outer surface of the cylinder body, and the moving body may include an engaging protrusion supported by the cylinder ring and protruding toward the cylinder body.

The moving body may include a contact protrusion protruding toward the cylinder body and contacting the outer surface of the cylinder body.

The central camera assembly may include a central camera and a camera housing accommodating the central camera.

The central camera may be rotatable with respect to the camera housing.

The posture adjustment device may include a sealing cover coupled to the base and configured to seal the at least one peripheral camera assembly from an outside environment.

### BRIEF DESCRIPTION OF DRAWINGS

The above and other aspects, features, and advantages of certain example embodiments of the present disclosure will be more apparent from the following description taken in conjunction with the accompanying drawings, in which:

FIG. 1 is a perspective view of a posture adjustment device according to an embodiment of the present disclosure;

FIG. 2 is an exploded perspective view of a posture adjustment device according to the embodiment of the present disclosure;

FIG. 3 is a diagram illustrating rotation of a central camera assembly with respect to a base according to an embodiment of the present disclosure;

FIG. 4 is a diagram illustrating rotation of peripheral camera assemblies with respect to a base according to an embodiment of the present disclosure;

FIG. 5 is an exploded perspective view of a base according to an embodiment of the present disclosure;

FIG. 6 is a bottom view of a base ring according to an embodiment of the present disclosure;

FIG. 7 is a cross-sectional view taken along line A-A′ of FIG. 5 according to an embodiment of the present disclosure;

FIG. 8 is a perspective view of a peripheral camera assembly according to an embodiment of the present disclosure;

FIG. 9 is a plan view of a peripheral camera assembly according to an embodiment of the present disclosure;

FIG. 10 is a side view of a peripheral camera assembly according to an embodiment of the present disclosure;

FIG. 11 is a bottom perspective view of a peripheral camera assembly according to an embodiment of the present disclosure;

FIG. 12 is a diagram illustrating a side cover separated from a moving body according to an embodiment of the present disclosure;

FIG. 13 is a diagram illustrating rotation of a peripheral camera with respect to a moving body according to an embodiment of the present disclosure;

FIG. 14 is a diagram illustrating a coupling relationship between a peripheral camera assembly and a base ring according to an embodiment of the present disclosure;

FIG. 15 is a diagram illustrating a moving body coupled to a base ring according to an embodiment of the present disclosure;

FIG. 16 is a diagram illustrating an engaging portion engaged with a guide ring according to an embodiment of the present disclosure; and

FIG. 17 is a diagram illustrating a moving body coupled to a base cylinder according to an embodiment of the present disclosure.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

Unless otherwise defined, all terms (including technical and scientific terms) used in the present disclosure may have meanings that may be commonly understood by those of ordinary skill in the art to which the present disclosure belongs. In addition, terms defined in a commonly used dictionary are not interpreted ideally or excessively unless explicitly defined specifically.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

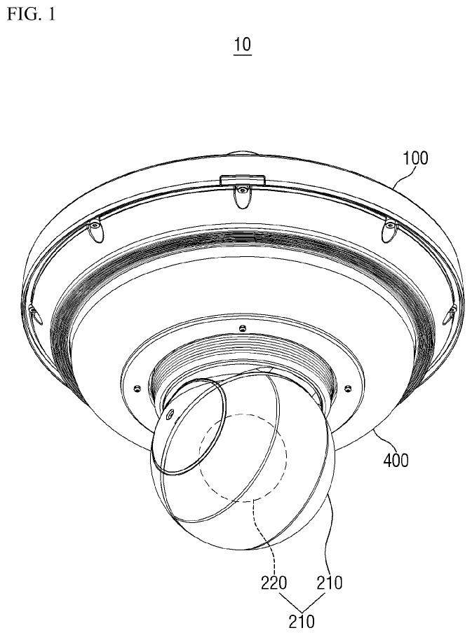

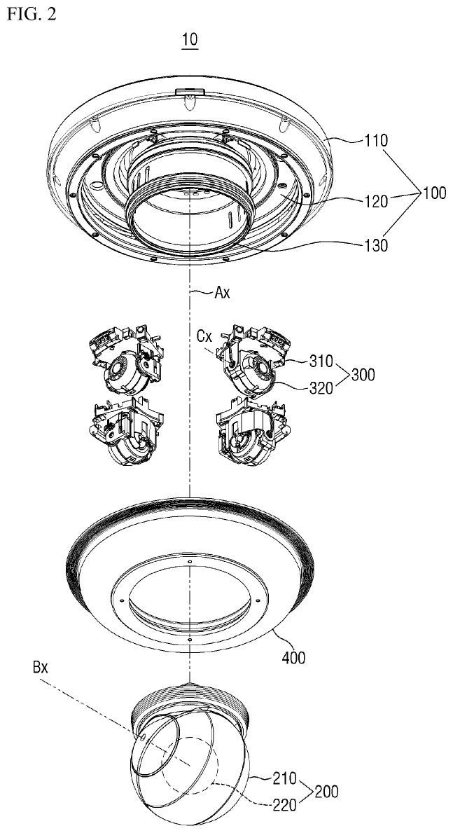

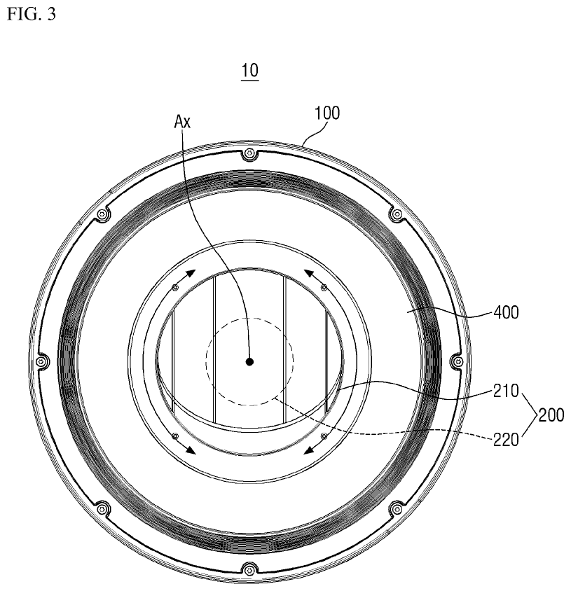

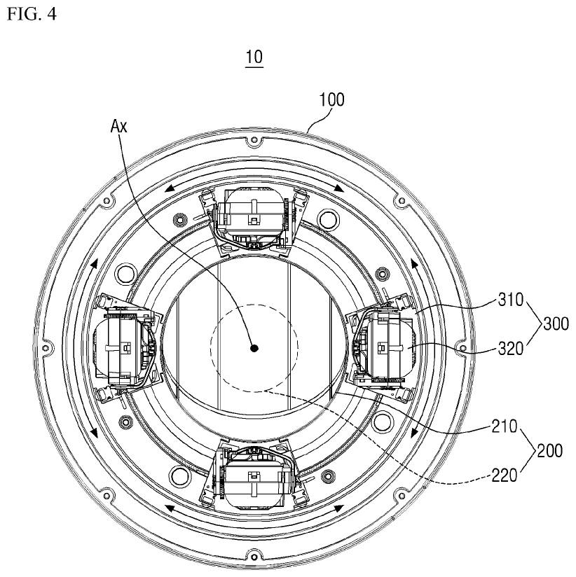

FIG. 1 is a perspective view of a posture adjustment device 10 according to an embodiment of the present disclosure. FIG. 2 is an exploded perspective view of the posture adjustment device 10 according to the embodiment of the present disclosure. FIG. 3 is a diagram illustrating rotation of a central camera assembly 200 with respect to a base 100 according to an embodiment of the present disclosure. FIG. 4 is a diagram illustrating rotation of peripheral camera assemblies 300 with respect to a base 100 according to an embodiment of the present disclosure.

Referring to FIGS. 1 and 2, the posture adjustment device 10 according to the embodiment of the present disclosure includes the base 100, the central camera assembly 200, the peripheral camera assemblies 300, and a sealing cover 400.

The base 100 includes a base body 110, a base ring 120, and a base cylinder 130. The base 100 may support the central camera assembly 200 and the peripheral camera assemblies 300. The base 100 may be coupled to an object on which it is to be installed. For example, the base 100 may be coupled to the ceiling or wall of a building. The central camera assembly 200 and the peripheral camera assemblies 300 may be coupled to the base 100 such that their positions with respect to the installation object may be determined.

The base unit 100 may include a rotation axis Ax that extends through a center the base 100. In some embodiments, the base 100 may be provided in the shape of a disk, and a central axis of the disk may correspond to the rotation axis Ax.

The central camera assembly 200 includes a camera housing 210 and a central camera 220. The central camera 220 may photograph a surveillance area within a preset range and generate an image of the surveillance area. The image generated by the central camera 220 may be a still image or a moving image. For example, the central camera 220 may be a visible light camera, a low light camera, or an infrared camera.

The camera housing 210 may accommodate the central camera 220. The central camera 220 may receive light passing through the camera housing 210 and generate an image by processing the light. To this end, a portion of the camera housing 210 which corresponds to the photographing direction of the central camera 220 may be made of a material that transmits light.

The central camera 220 may rotate with respect to the camera housing 210. Specifically, the central camera 220 may tilt and rotate with respect to the camera housing 210. A rotation axis Bx (hereinafter, referred to as a central rotation axis), about which the central camera 220 rotates with respect to the camera housing 210, may be different from the rotation axis Ax of the base 100. For example, the central rotation axis Bx may extend in a direction perpendicular to the rotation axis Ax of the base 100. To rotate the central camera 220 with respect to the camera housing 210, a driver such as a motor and a gear may be provided inside the camera housing 210.

The central camera assembly 200 may be coupled to the base 100 such that it may rotate about the rotation axis Ax of the base 100. Referring to FIG. 3, the central camera assembly 200 may rotate about the rotation axis Ax. As the central camera assembly 200 rotates about the rotation axis Ax and the central camera 220 tilts and rotates with respect to the camera housing 210, the central camera 220 may be adjusted to various postures with respect to the installation object.

Referring to FIGS. 1 and 2 again, each of the peripheral camera assemblies 300 includes a moving body 310 and a peripheral camera 320. The peripheral camera 320 may photograph a surveillance area within a preset range and generate an image of the surveillance area. The image generated by the peripheral camera 320 may be a still image or a moving image. For example, the peripheral camera 320 may be a visible light camera, a low light camera, or an infrared camera.

The moving body 310 may support the peripheral camera 320. In addition, the moving body 310 may be coupled to the base 100. The position of the peripheral camera 320 with respect to the base 100 may be determined through the moving body 310.

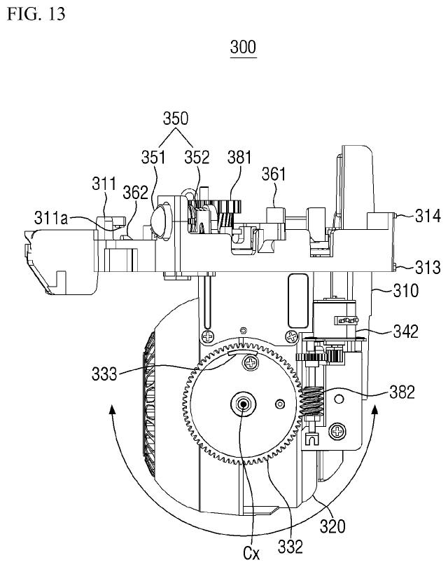

The peripheral camera 320 may rotate with respect to the moving body 310. Specifically, the peripheral camera 320 may tilt and rotate with respect to the camera housing 210. A rotation axis Cx (hereinafter, referred to as a peripheral rotation axis), about which the peripheral camera 320 rotates with respect to the moving body 310, may be different from the rotation axis Ax of the base 100. For example, the peripheral rotation axis may extend in a direction perpendicular to the rotation axis Ax of the base 100. The rotation of the peripheral camera 320 with respect to the moving body 310 will be described later with reference to FIG. 13.

The peripheral camera assemblies 300 may be coupled to the base 100 so as to revolve around the rotation axis Ax of the base 100. Referring to FIG. 4, the peripheral camera assemblies 300 may revolve around the rotation axis Ax. That is, the peripheral camera assemblies 300 may be configured to move along a circular path around the rotation axis Ax (e.g., the peripheral camera assemblies 300 may move around the central camera assembly 200).

In some embodiments, a plurality of peripheral camera assemblies 300 may be provided. The peripheral camera assemblies 300 may perform photographing while moving around the central camera assembly 200. The photographing directions of the peripheral camera assemblies 300 may extend in a radial direction from the rotation axis Ax of the base 100. Since the peripheral camera assemblies 300 photograph different directions, a wide range may be monitored.

The sealing cover 400 may be provided in the shape of a ring and coupled to the base 100. A through hole through which the base cylinder 130 of the base 100 passes may be formed in the sealing cover 400. The base cylinder 130 and the central camera assembly 200 may be coupled to each other through the through hole of the sealing cover 400.

The sealing cover 400 may seal the peripheral camera assemblies 300 from the outside environment. The peripheral camera 320 included in each of the peripheral camera assemblies 300 may receive light passing through the sealing cover 400 and generate an image by processing the light. To this end, a portion of the sealing cover 400 which corresponds to the photographing direction of the peripheral camera 320 may be made of a material that transmits light.

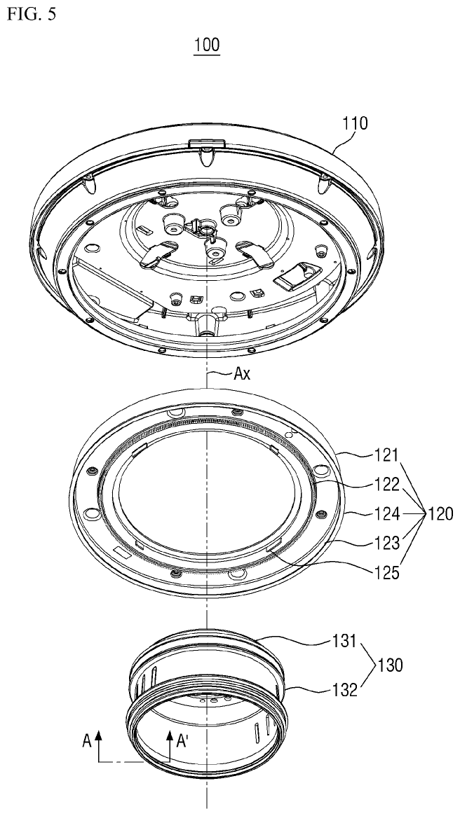

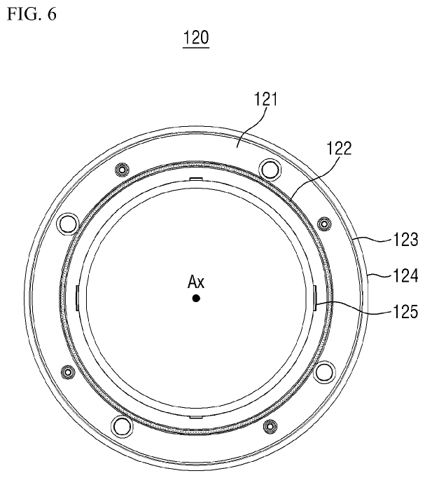

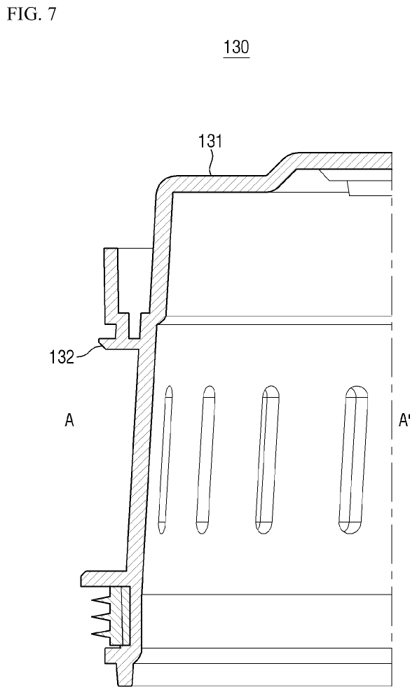

FIG. 5 is an exploded perspective view of the base 100 according to an embodiment of the present disclosure. FIG. 6 is a bottom view of the base ring 120 according to an embodiment of the present disclosure. FIG. 7 is a cross-sectional view taken along line A-A′ of FIG. 5 according to an embodiment of the present disclosure.

Referring to FIG. 5, the base 100 includes the base body 110, the base ring 120, and the base cylinder 130.

The base body 110 may provide a reference position of the posture adjustment device 10. The base body 110 may be coupled to the installation object described above. The central camera assembly 200 and the peripheral camera assemblies 300 may be indirectly coupled to the base body 110 such that their positions with respect to the installation object may be determined.

The base body 110 may form a certain internal space. Various parts for the operation of the central camera assembly 200 and the peripheral camera assemblies 300 may be accommodated in the internal space. The base body 110 may include a circular opening that connects the internal space to the outside. Various cables for operating and controlling the central camera assembly 200 and the peripheral camera assemblies 300 may be connected to the central camera assembly 200 and the peripheral camera assemblies 300 through the opening.

The base ring 120 may be provided in the shape of a ring and coupled to the opening of the base body 110. The base ring 120 may provide a movement path for the peripheral camera assemblies 300. The peripheral camera assemblies 300 may move along an arc-shaped movement path corresponding to the base ring 120. As described above, the posture adjustment device 10 may include a plurality of peripheral camera assemblies 300. The peripheral camera assemblies 300 may individually move along the base ring 120. For example, all of the peripheral camera assemblies 300 included in the posture adjustment device 10 may move simultaneously in the same direction and by the same angle. Alternatively, some of the peripheral camera assemblies 300 included in the posture adjustment device 10 may move simultaneously in the same direction and by the same angle, and the other peripheral camera assemblies 300 may move in different directions and by different angles. Alternatively, all of the peripheral camera assemblies 300 included in the posture adjustment device 10 may move in different directions and by different angles.

Referring to FIGS. 5 and 6, the base ring 120 may include a ring body 121, a ring gear 122, a support ring 123, a guide ring 124, and first interrupters 125. The ring body 121 may be provided in the shape of a ring having the rotation axis Ax of the base 100 as its central axis. A through hole through which the base cylinder 130 passes may be formed in the ring body 121.

The ring gear 122 may be formed on a lower surface of the ring body 121. The ring gear 122 may be gear-coupled to power gears of the peripheral camera assemblies 300 which will be described later. The peripheral camera assemblies 300 may move along the ring gear 122.

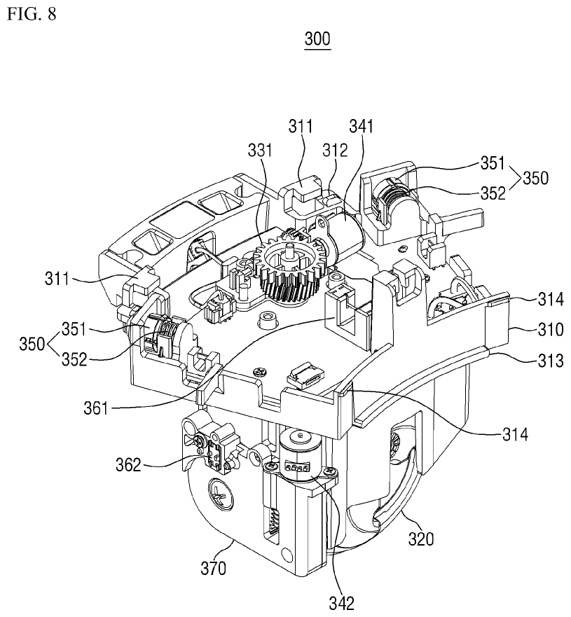

The support ring 123 may be formed on an outer surface of the ring body 121. The support ring 123 may be formed in the shape of a ring around the ring gear 122. The support ring 123 may support force providing assemblies 350 (see FIG. 8) which will be described later. The force providing assemblies 350 supported by the support ring 123 may bring the power gears into close contact with the ring gear 122.

The guide ring 124 may protrude from the outer surface of the ring body 121. Specifically, the guide ring 124 may protrude from the support ring 123. The guide ring 124 may support the peripheral camera assemblies 300. The peripheral camera assemblies 300 may move along the guide ring 124 which being supported by the guide ring 124.

The first interrupters 125 may be provided on the lower surface of the ring body 121. The first interrupters 125 may be detected by first photo interrupter sensors 361 (see FIG. 8) included in the peripheral camera assemblies 300 which will be described later and may be used to identify initial positions of the peripheral camera assemblies 300. A plurality of first interrupters 125 may be provided. For example, a number of first interrupters 125 equal to the number of peripheral camera assemblies 300 may be provided on the ring body 121. However, the case where the number of peripheral camera assemblies 300 and the number of first interrupters 125 are equal is only an example, and two or more first interrupters 125 may also be provided on the ring body 121 regardless of the number of peripheral camera assemblies 300. When two or more first interrupters 125 are provided on the ring body 121, adjacent first interrupters 125 may have different sizes. The position of a peripheral camera assembly 300 including a first photo interrupter sensor 361 may be determined based on the shape of a first interrupter 125 detected by the first photo interrupter sensor 361.

Referring to FIG. 5 again, the base cylinder 130 may be coupled to the base body 110. The base cylinder 130 may extend from an inner wall of the base body 110 toward the opening of the base body 110. For example, the base cylinder 130 may pass through the center of the base ring 120, and a portion of the base cylinder 130 may be exposed out of the base body 110. The base body 110 may be provided in the shape of a disk, and the base cylinder 130 may be provided in the shape of a cylinder. A central axis of the base body 110 and a central axis of the base cylinder 130 may coincide.

The central camera assembly 200 may be coupled to an end of the base cylinder 130 which is not coupled to the base body 110. Specifically, the central camera assembly 200 may be rotatably coupled to the base cylinder 130. The central axis of the base cylinder 130 described above may correspond to the rotation axis Ax of the base 100. The central camera assembly 200 may rotate about the rotation axis Ax.

Referring to FIGS. 5 and 7, the base cylinder 130 may include a cylinder body 131 and a cylinder ring 132.

The cylinder body 131 may be provided in the shape of a cylinder and coupled to the base 100. A central axis of the cylinder body 131 may coincide with a central axis of the base 100.

The cylinder ring 132 may protrude from an outer surface of the cylinder body 131. The cylinder ring 132 may support the peripheral camera assemblies 300. The peripheral camera assemblies 300 may move along the cylinder ring 132 while being supported by the cylinder ring 132. As described above, the peripheral camera assemblies 300 may be supported by the guide ring 124 of the base ring 120. One side of each of the peripheral camera assemblies 300 may be supported by the guide ring 124, and the other side of each of the peripheral camera assemblies 300 may be supported by the cylinder ring 132.

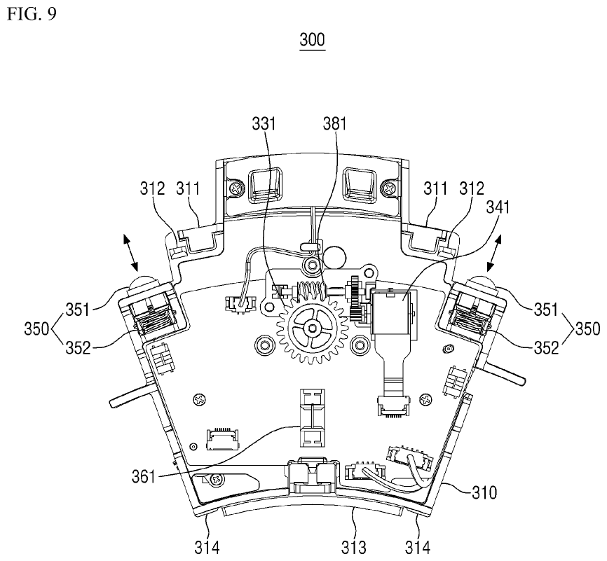

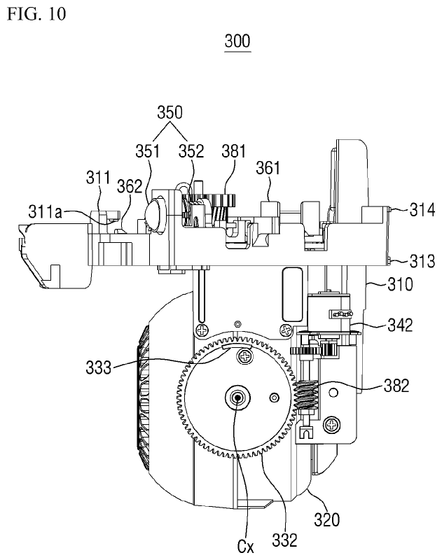

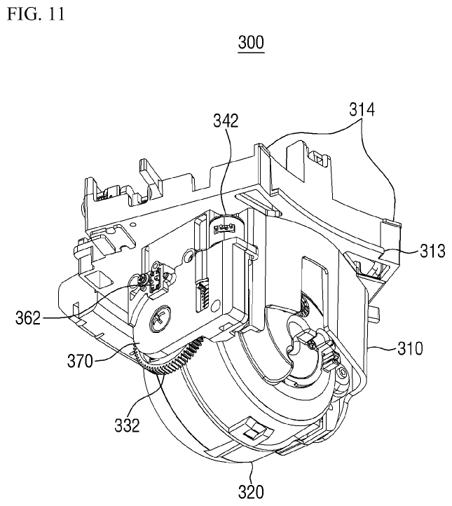

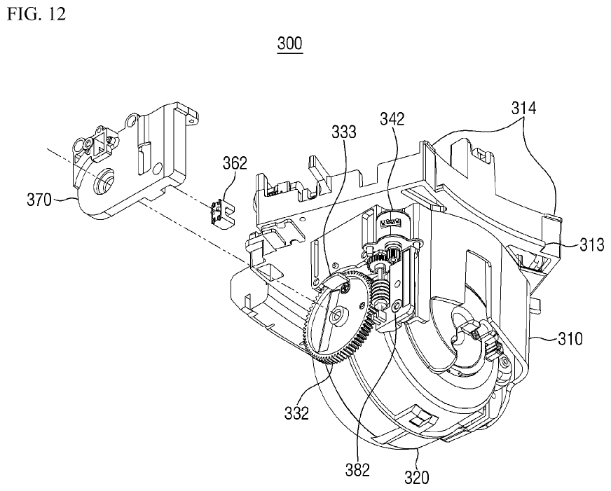

FIG. 8 is a perspective view of a peripheral camera assembly 300 according to an embodiment of the present disclosure. FIG. 9 is a plan view of the peripheral camera assembly 300 according to an embodiment of the present disclosure. FIG. 10 is a side view of the peripheral camera assembly 300 according to an embodiment of the present disclosure. FIG. 11 is a bottom perspective view of the peripheral camera assembly 300 according to an embodiment of the present disclosure. FIG. 12 is a diagram illustrating a side cover 370 separated from a moving body 310 according to an embodiment of the present disclosure. FIG. 13 is a diagram illustrating rotation of a peripheral camera 320 with respect to a moving body 310 according to an embodiment of the present disclosure.

Referring to FIGS. 8 through 10, the peripheral camera assembly 300 includes the moving body 310, the peripheral camera 320, a first power gear 331, a first power motor 341, a second power gear 332, a second power motor 342, force providing assemblies 350, a first photo interrupter sensor 361, a second photo interrupter sensor 362, and the side cover 370.

The moving body 310 may be integrated with the peripheral camera assembly 300. Various parts included in the peripheral camera assembly 300 may be directly or indirectly coupled to the moving body 310.

The moving body 310 may move along the base ring 120 of the base 100. When the moving body 310 moves, various components coupled to the moving body 310 may also move together with the moving body 310.

The moving body 310 may include engaging portions 311. For example, the engaging portions 311 may be formed on an outer circumferential surface of the moving body 310. The engaging portions 311 may be engaged with the guide ring 124 of the base ring 120. Each of the engaging portions 311 may include an engaging protrusion 311a. The engaging protrusions 311a may be formed to protrude toward a surface of the guide ring 124. The moving body 310 may include body protrusions 312. The body protrusions 312 may be formed to protrude toward a surface opposite the surface of the guide ring 124 that the engaging protrusions 311a face. Since the engaging protrusions 311a and the body protrusions 312 are brought into close contact with both sides of the guide ring 124, the movement of the moving body 310 with respect to the guide ring 124 may be prevented. In addition, since the engaging protrusions 311a and the body protrusions 312 contact a relatively small area of the guide ring 124, a relatively small frictional force may be formed between the guide ring 124 and the moving body 310, and the moving body 310 may be easily rotated.

The engaging portions 311 is detachable from the moving body 310. For example, the engaging portions 311 may be snap-fitted to the moving body 310. To this end, one of each engaging portion 311 and the moving body 310 may include a latch, and the other may include an engaging groove. Since the engaging portions 311 may be coupled to the moving body 310 without using a separate fastening member such as a screw, a user may easily couple the engaging portions 311 to the moving body 310. In addition, when the engaging protrusions 311a of the engaging portions 311 are worn, the movement of the moving body 310 with respect to the guide ring 124 may increase. In this case, the user may reduce the movement of the moving body 310 with respect to the guide ring 124 by replacing the engaging portions 311.

The moving body 310 may include an engaging protrusion 313. For example, the engaging protrusion 313 may be formed on an inner circumferential surface of the moving body 310. The engaging protrusion 313 may protrude toward the cylinder body 131 of the base cylinder 130 and may be supported by the cylinder ring 132. The moving body 310 may move around the base cylinder 130 while being supported by the cylinder ring 132.

The moving body 310 may include contact protrusions 314. The contact protrusions 314 may protrude toward the cylinder body 131 of the base cylinder 130 and may contact a surface of the cylinder body 131. As will be described later, the moving body 310 may be brought into close contact with the cylinder body 131 of the base cylinder 130 by the force providing assemblies 350. If the inner circumferential surface of the moving body 310 directly contacts the surface of the cylinder body 131, an excessively large frictional force may be generated, thus restricting the movement of the moving body 310 with respect to the base cylinder 130. However, since the contact protrusions 314 contact a relatively small area of the cylinder body 131, a relatively small frictional force may be formed between the moving body 310 and the cylinder body 131, and the moving body 310 may be easily rotated.

The peripheral camera 320 may be coupled to the moving body 310. Specifically, the peripheral camera 320 may be rotatably coupled to the moving body 310. The peripheral camera 320 may tilt and rotate with respect to the moving body 310.

The first power gear 331 may be gear-coupled to the ring gear 122. The first power gear 331 may rotate while being gear-coupled to the ring gear 122.

The first power motor 341 may generate a rotational force to rotate the first power gear 331. A first transmission gear 381 may be provided between the first power motor 341 and the first power gear 331. The first transmission gear 381 may transmit the rotational force of the first power motor 341 to the first power gear 331.

The first power motor 341 may be fixed to the moving body 310. When the first power gear 331 is rotated by the rotational force of the first power motor 341, the moving body 310 may be moved along the ring gear 122 by the gear coupling between the first power gear 331 and the ring gear 122.

The force providing assemblies 350 may generate force to bring the first power gear 331 into close contact with the ring gear 122. Each of the force providing assemblies 350 includes a bullet 351 and an elastic portion 352. The bullet 351 may be movably coupled to the moving body 310. For example, the bullet 351 may move in a direction parallel to a direction extending radially from the rotation axis Ax of the base 100. The bullet 351 may contact the support ring 123 of the base ring 120.

The elastic portion 352 may provide the bullet 351 with an elastic force toward the support ring 123. For example, the elastic portion 352 may provide the bullet 351 with an elastic force acting in a direction extending radially from the rotation axis Ax of the base 100. The bullet 351 may be made to press the support ring 123 by the elastic force of the elastic portion 352.

As the bullet 351 presses the support ring 123, a force toward the rotation axis Ax may be generated by the bullet 351. The force may act on the moving body 310. In some embodiments, the force providing assemblies 350 may be disposed on both sides of the first power gear 331. That is, two force providing assemblies 350 are respectively disposed on both sides of the first power gear 331 to generate a force for moving the moving body 310.

Distances between the first power gear 331 and the force providing assemblies 350 on both sides of the first power gear 331 may be equal. In this case, a force toward the rotation axis Ax may be generated by the first power gear 331. The force may act as a force that brings the first power gear 331 into close contact with the ring gear 122.

As the first power gear 331 is brought into close contact with the ring gear 122 by the force generated by the force providing assemblies 350, the peripheral camera assembly 300 may move along the base ring 120 while the movement of the peripheral camera assembly 300 and the base ring 120 with respect to each other is prevented.

The first photo interrupter sensor 361 may detect a first interrupter 125 included in the base ring 120. The detection result of the first photo interrupter sensor 361 may be used to identify the position of the moving body 310 with respect to the base ring 120.

Referring to FIGS. 10 through 13, the second power gear 332 may be coupled to the peripheral camera 320. The second power gear 332 may rotate while being coupled to the peripheral camera 320.

The second power motor 342 may generate a rotational force to rotate the second power gear 332. A second transmission gear 382 may be provided between the second power motor 342 and the second power gear 332. The second transmission gear 382 may transmit the rotational force of the second power motor 342 to the second power gear 332.

The second power motor 342 may be fixed to the moving body 310. When the second power gear 332 is rotated by the rotational force of the second power motor 342, the peripheral camera 320 coupled to the second power gear 332 may rotate with respect to the moving body 310.

The second power gear 332 may have a second interrupter 333. The second photo interrupter sensor 362 may detect the second interrupter 333 provided on the second power gear 332. The detection result of the second photo interrupter sensor 362 may be used to identify an initial angle of the peripheral camera 320 with respect to the moving body 310.

The second photo interrupter sensor 362 may be fixed to the side cover 370. The side cover 370 may be coupled to the moving body 310 while sealing the second power gear 332 and the second transmission gear 382. In addition, the side cover 370 may provide a reference about which the second power gear 332 rotates. The second power motor 342 may be coupled to the side cover 370. The second power motor 342 may be coupled to the moving body 310 through the side cover 370.

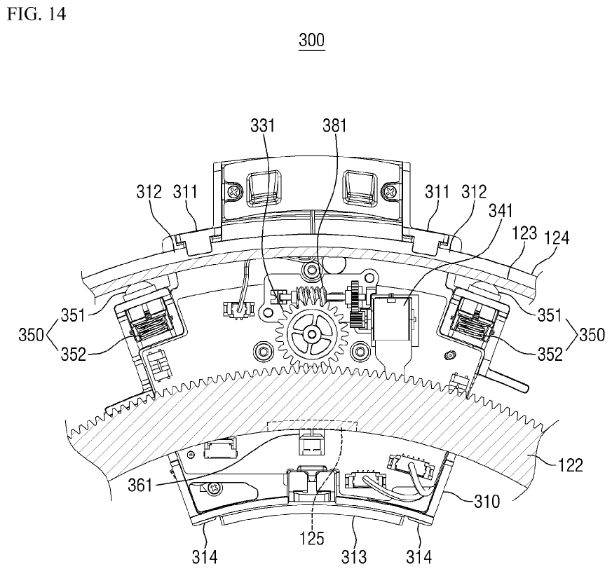

FIG. 14 is a diagram illustrating a coupling relationship between a peripheral camera assembly 300 and a base ring 120 according to an embodiment of the present disclosure.

Referring to FIG. 14, the peripheral camera assembly 300 may be coupled to the base ring 120.

The first power gear 331 of the peripheral camera assembly 300 may be gear-coupled to the ring gear 122 of the base ring 120. The bullets 351 of the force providing assemblies 350 may press the support ring 123. As the bullets 351 press the support ring 123, the first power gear 331 may be brought into close contact with the ring gear 122. Even while the peripheral camera assembly 300 is rotating with respect to the base ring 120, the first power gear 331 and the ring gear 122 may be firmly kept coupled to each other.

The base ring 120 may have a first interrupter 125. The first interrupter 125 may be detected by the first photo interrupter sensor 361 included in the peripheral camera assembly 300. The detection result of the first photo interrupter sensor 361 may be used to determine the initial position of the peripheral camera assembly 300 with respect to the base 100.

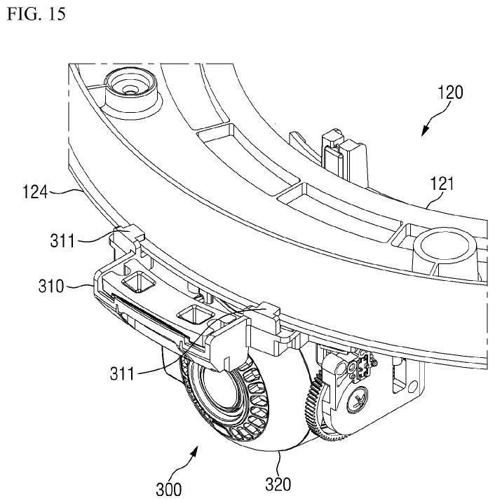

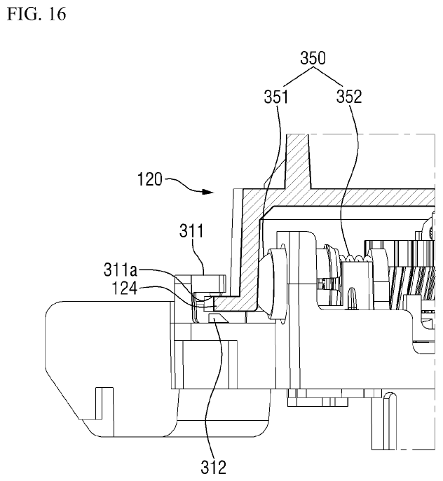

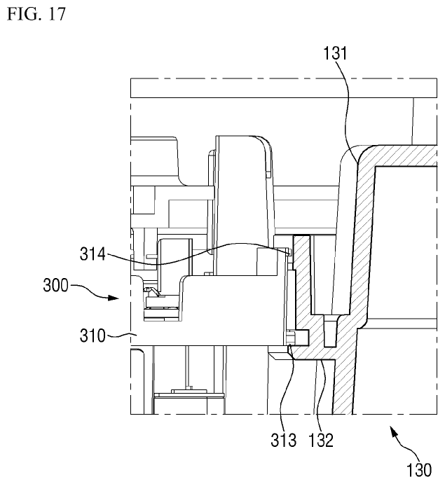

FIG. 15 is a diagram illustrating a moving body 310 coupled to a base ring 120 according to an embodiment of the present disclosure. FIG. 16 is a diagram illustrating an engaging portion 311 engaged with a guide ring 124 according to an embodiment of the present disclosure. FIG. 17 is a diagram illustrating a moving body 310 coupled to a base cylinder 130 according to an embodiment of the present disclosure.

Referring to FIGS. 15 through 17, the moving body 310 of a peripheral camera assembly 300 may be coupled to the base ring 120 and the base cylinder 130.

The moving body 310 may include the engaging portions 311 and the engaging protrusion 313. The engaging portions 311 may be engaged with the guide ring 124 of the base ring 120, and the engaging protrusion 313 may be supported by the cylinder ring 132 of the base cylinder 130.

The engaging portions 311 may be formed on the outer circumferential surface of the moving body 310, and the engaging protrusion 313 may be formed on the inner circumferential surface of the moving body 310. In a state where the engaging portions 311 are engaged with the guide ring 124 and the engaging protrusion 313 is supported by the base ring 120, the moving body 310 may move along the base ring 120.

The engaging coupling portions 311 may include the engaging protrusions 311a protruding toward a surface of the guide ring 124, and the moving body 310 may include the body protrusions 312 protruding toward a surface opposite the surface of the guide ring 124 that the engaging protrusions 311a face. The guide ring 124 may be inserted between the engaging protrusions 311a and the body protrusions 312. A gap between the engaging protrusions 311a and the body protrusions 312 may be greater than a thickness of the guide ring 124. The gap between the engaging protrusions 311a and the body protrusions 312 may be similar to the thickness of the guide ring 124. Accordingly, the movement of the moving body 310 with respect to the base ring 120 may be prevented.

The bullets 351 of the force providing assemblies 350 may press the support ring 123. In this case, the first power gear 331 may be brought into close contact with the ring gear 122, causing the moving body 310 to be brought into close contact with the base cylinder 130. If the inner circumferential surface of the moving body 310 directly contacts the surface of the cylinder body 131 of the base cylinder 130, the movement of the moving body 310 may be restricted. The moving body 310 may include the contact protrusions 314 protruding toward the cylinder body 131 and contacting the surface of the cylinder body 131. Since the contact protrusions 314 having a relatively small contact area contact the surface of the cylinder body 131, the moving body 310 may be easily moved.

With a posture adjustment device of the present disclosure described above, a plurality of different points may be monitored with lower installation costs and management costs by enabling the positions of peripheral cameras to be adjusted around a central camera.

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. A posture adjustment device comprising:
a base having a rotation axis that extends through a center of the base;
a central camera assembly coupled to the base and configured to rotate about the rotation axis; and
at least one peripheral camera assembly coupled to the base and configured to revolve around the rotation axis.

2. The posture adjustment device of claim 1, wherein the base comprises a base ring providing a movement path for the at least one peripheral camera assembly.

3. The posture adjustment device of claim 2, wherein the at least one peripheral camera assembly comprises a plurality of peripheral camera assemblies, and
wherein each of the plurality of peripheral camera assemblies is configured individually move along the base ring.

4. The posture adjustment device of claim 2, wherein the at least one peripheral camera assembly comprises:
a moving body configured to move along the base ring; and
a peripheral camera coupled to the moving body.

5. The posture adjustment device of claim 4, wherein the base ring comprises a ring gear, and
wherein the at least one peripheral camera assembly further comprises:
a first power gear coupled to the ring gear; and
a first power motor configured to generate a rotational force to rotate the first power gear.

6. The posture adjustment device of claim 5, wherein the at least one peripheral camera assembly further comprises a force providing assembly configured to generate a force to bring the first power gear into contact with the ring gear.

7. The posture adjustment device of claim 6, wherein the base ring further comprises a support ring around the ring gear, and
wherein the force providing assembly comprises:
a bullet movably coupled to the moving body and contacting the support ring; and
an elastic portion providing the bullet with an elastic force directed toward the support ring.

8. The posture adjustment device of claim 6, wherein the force providing assembly is provided on both sides of the first power gear.

9. The posture adjustment device of claim 4, wherein the base ring comprises:
a ring body having a central axis that corresponds to the rotation axis of the base; and
a guide ring protruding from an outer surface of the ring body, and
wherein the moving body comprises an engaging portion configured to engage with the guide ring.

10. The posture adjustment device of claim 9, wherein the engaging portion comprises an engaging protrusion protruding toward a first surface of the guide ring.

11. The posture adjustment device of claim 10, wherein the moving body comprises a body protrusion protruding toward a second surface of the guide ring that is opposite the first surface of the guide ring that the engaging protrusion protrudes toward.

12. The posture adjustment device of claim 9, wherein the engaging portion is detachable from the moving body.

13. The posture adjustment device of claim 4, wherein the peripheral camera is rotatably coupled to the moving body.

14. The posture adjustment device of claim 4, wherein the base further comprises a base cylinder provided at a center of the base ring.

15. The posture adjustment device of claim 14, wherein the central camera assembly is rotatably coupled to the base cylinder.

16. The posture adjustment device of claim 14, wherein the base cylinder comprises:
a cylinder body; and
a cylinder ring protruding from an outer surface of the cylinder body, and
wherein the moving body comprises an engaging protrusion supported by the cylinder ring and protruding toward the cylinder body.

17. The posture adjustment device of claim 16, wherein the moving body comprises a contact protrusion protruding toward the cylinder body and contacting the outer surface of the cylinder body.

18. The posture adjustment device of claim 1, wherein the central camera assembly comprises:
a central camera; and
a camera housing accommodating the central camera.

19. The posture adjustment device of claim 18, wherein the central camera is rotatable with respect to the camera housing.

20. The posture adjustment device of claim 1, further comprising a sealing cover coupled to the base and configured to seal the at least one peripheral camera assembly from an outside environment.
